(19) United States
(12) Patent Application Publication
(10) Pub. No.: US 2016/0016777 A1
(43) Pub. Date: Jan. 21, 2016

(54) WATER DISPENSER

(71) Applicant: KABUSHIKI KAISHA COSMO LIFE, Kakogawa-shi, Hyogo (JP)

(72) Inventor: Yoshinori ORITA, Hyogo (JP)

(21) Appl. No.: 14/771,815

(22) PCT Filed: Dec. 16, 2013
(86) PCT No.: PCT/JP2013/083569

§ 371 Date: Sep. 1, 2015

(30) Foreign Application Priority Data
Mar. 5, 2013 (JP) 2013-042976

(51) Int. Cl. B67D 1/08; B67D 1/10; B67D 1/00

(52) U.S. Cl. CPC B67D 1/0895; B67D 1/001; B67D 1/10; B67D 1/0888

(57) ABSTRACT

A water dispenser includes: a heater for heating drinking water in a hot water tank; a circulation route through which drinking water is circulated by way of the hot water tank; a pump provided in the circulation route; and a control device. During sterilization operation, the control device carries out a heater control in which the heater is turned on and off when the temperature in the hot water tank falls below a lower limit, and increased to an upper limit, respectively, concurrently with an intermittent pump drive control in which the pump is deactivated while the temperature in the hot water tank is lower than the lower limit, and driven continuously for a predetermined period of time when the temperature in the hot water tank is increased to the lower limit by the heater control.

### TECHNICAL FIELD

The present invention relates to a water dispenser which supplies drinking water from a replaceable raw water container filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A water dispenser generally includes a cold water tank configured to store low temperature drinking water to be discharged to the outside, and a hot water tank configured to store high temperature drinking water to be discharged to the outside.

Further, conventionally, a water dispenser has been proposed which includes a circulation route configured such that drinking water can be circulated through the circulation route by way of the hot water tank; and a pump provided at an intermediate portion of the circulation route, in order to maintain the interior of the water dispenser sanitary (for example, see FIG. 2 in the below-identified Patent Document 1).

In the water dispenser disclosed in FIG. 2 in Patent Document 1, high temperature drinking water can be circulated through the circulation route to sterilize the circulation route including the cold water tank at a high temperature, by driving the pump with a heater provided in the hot water tank turned on.

### PRIOR ART DOCUMENTS

### Patent Documents

Patent Document 1 JP 3387526 B

### SUMMARY OF THE INVENTION

### Problems to be Solved by the Invention

In order to improve the sanitation of the water dispenser, the present inventor has investigated if it is possible to carry out the sterilization operation of the circulation route more frequently, for example, once in every two or three days (preferably, once a day). The investigation has revealed that, when the sterilization operation is carried out frequently, there is a potential risk that a long service life of the pump may not be secured, because the total number of revolutions of the pump is increased within a relatively short period of time.

Accordingly, an object of the present invention is to provide a water dispenser in which a long service life of the pump can be secured even if the sterilization operation is carried out more frequently.

### Means for Solving the Problems

The present inventor has come to realize, while investigating a solution to the above mentioned problems, the possibility that the number of revolutions required for the pump to carry out one sterilization operation could be reduced by driving the pump intermittently when circulating high temperature drinking water.

This can be described as follows. In order to early out the sterilization of the circulation route by circulating high temperature drinking water in the hot water tank, in general, the pump is driven while a heater control of the hot water tank is carried out. At this time, the pump is driven continuously without being stopped, from the start until the end of the sterilization operation. The heater control of the hot water tank is configured such that the heater is turned on when the temperature in the hot water tank falls below a predetermined lower limit temperature, and the heater is turned off when the temperature in the hot water tank is increased to reach a predetermined upper limit temperature.

However, the present inventor has realized the fact that, when the above described conventional sterilization operation is carried out, the pump keeps rotating without stopping, even while the temperature of the circulating drinking water has not yet been increased to a sterilization temperature, thereby increasing the total number of revolutions of the pump required per one sterilization operation, more than necessary. This has led the inventor to an idea, in order to reduce the total number of revolutions of the pump required per sterilization operation, to drive the pump intermittently such that the pump is maintained in a deactivated state while the temperature in the hot water tank has not yet been increased to the sterilization temperature, and to drive the pump continuously for a predetermined period of time when the temperature in the hot water tank has been increased to the sterilization temperature.

Based on this idea, the present invention has adopted the following constitution:

A water dispenser including:

a hot water tank configured to store high temperature drinking water to be discharged to outside of the water dispenser;

a heater configured to heat the drinking water in the hot water tank;

a circulation route configured such that drinking water can be circulated through the circulation route by way of the hot water tank;

a pump provided at an intermediate portion of the circulation route; and

a control device configured to control the heater and the pump such that the circulation route can be sterilized at a high temperature with the high temperature drinking water in the hot water tank;

wherein, during a sterilization operation of the circulation route, the control device is configured to perform:

a heater control in which the control device turns on the heater when a temperature in the hot water tank falls below a predetermined lower limit temperature, and turns off the heater when the temperature in the hot water tank is increased to reach a predetermined upper limit temperature, concurrently with

an intermittent pump drive control in which the control device performs a first operation in which the pump is maintained in a deactivated state while the temperature in the hot water tank is lower than a predetermined high temperature, alternately with a second operation in which the pump is driven continuously for a predetermined period of time when the temperature in the hot water tank is increased to reach the predetermined high temperature by the heater control.

Since, with this arrangement, when the sterilization operation of the circulation route is carried out, the pump is maintained in a deactivated state while the temperature in the hot water tank has not yet been increased to the predetermined high temperature, and the pump is driven to pump out high temperature drinking water from the hot water tank when the temperature in the hot water tank is increased to the predetermined high temperature, it is possible to reduce the total number of revolutions of the pump required until the overall temperature of the drinking water circulating through the circulation route is increased to the sterilization temperature. Accordingly, the total number of revolutions of the pump required per sterilization operation can be reduced, and it is possible to secure a long service life of the pump even when the sterilization operation is carried out frequently.

In the above mentioned water dispenser, the predetermined period of time, which is the length of time during which the pump is driven continuously in the above mentioned second operation, is preferably determined to be the same as, or shorter than, the period of time required for the pump to pump out the amount of drinking water equivalent to the capacity of the hot water tank. In other words, by the time the pump has pumped out the amount of drinking water equivalent to the capacity of the hot water tank, it is considered that the high temperature drinking water in the hot water tank has been substantially completely replaced, and continuously driving the pump any further will only unnecessarily shorten the life of the pump. Therefore, as described above, if the predetermined period of time during which the pump is driven continuously in the second operation is determined to be the same as, or shorter than, the period of time required for the pump to pump out the amount of drinking water equivalent to the capacity of the hot water tank, it is possible to efficiently prolong the service life of the pump, without unnecessarily driving the pump.

### Effect of the Invention

In the water dispenser according to the present invention, when the sterilization operation of the circulation route is carried out, the pump is driven to pump out high temperature drinking water from the hot water tank when the temperature in the hot water tank is increased to the predetermined high temperature, and the pump is maintained in a deactivated state until then. This serves to reduce the total number of revolutions of the pump required until the overall temperature of the drinking water circulating through the circulation route is increased to the sterilization temperature. Accordingly, the total number of revolutions of the pump required per sterilization operation can be reduced, and it is possible to secure a long service life of the pump even when the sterilization operation is carried out frequently. As a result, the sanitation of the water dispenser can be improved.

### BRIEF DESCRIPTION OF THE DRAWINGS

FIG. 1 is a sectional view of a water dispenser embodying the present invention, when it is in a normal operation mode.

FIG. 2 is a sectional view of the water dispenser shown in FIG. 1, when it is in a sterilization operation mode.

FIG. 3 is a sectional view of the water dispenser shown in FIG. 1, illustrating the state in which low temperature drinking water is being discharged form a cold water tank.

FIG. 4 is a sectional view of the water dispenser shown in FIG. 1, illustrating the state in which high temperature drinking water is being discharged form a hot water tank.

FIG. 5 is a sectional view showing the vicinity of a container holder shown in FIG. 1, illustrating the state in which the container holder has been pulled out of a housing.

FIG. 6 is a block diagram showing the scheme of a control device of the water dispenser shown in FIG. 1.

FIG. 7 is a flow diagram illustrating how a heater control of the hot water tank is carried out by the control device shown in FIG. 6.

FIG. 8 is a flow diagram illustrating how an intermittent pump drive control during the sterilization operation mode is carried out by the control device shown in the FIG. 6.

### MODE FOR CARRYING OUT THE INVENTION

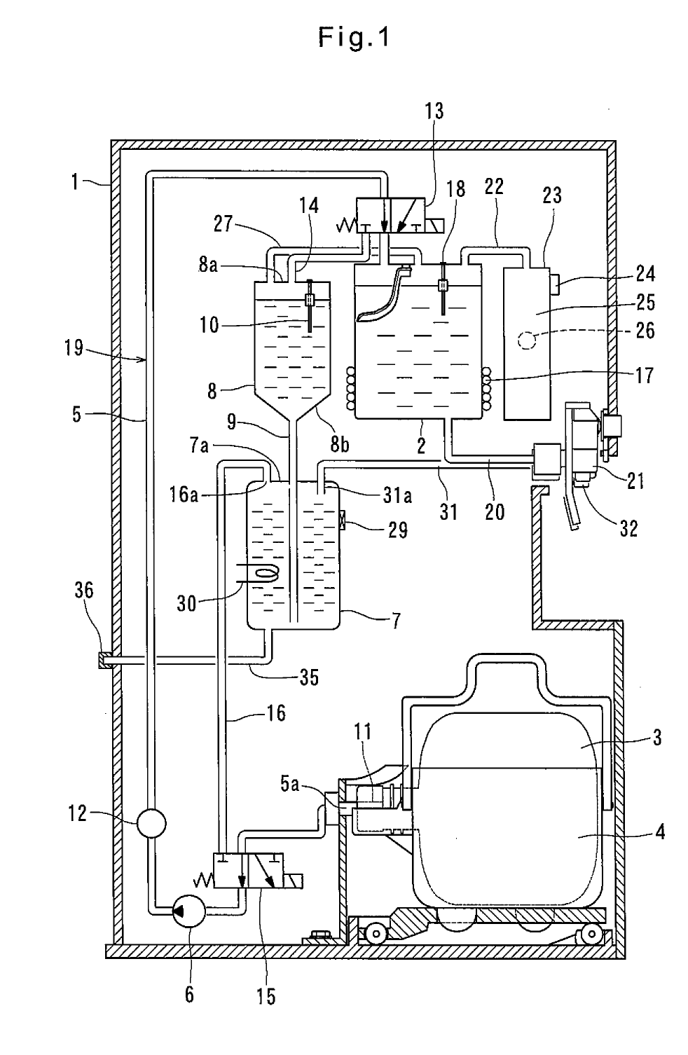

A water dispenser embodying the present invention is shown in FIG. 1. This water dispenser includes: a housing 1; a cold water tank 2 configured to store low temperature drinking water so that the low temperature drinking water can be discharged to the outside of the housing 1; a replaceable raw water container 3 filled with drinking water to be supplied to the cold water tank 2; a container holder 4 configured to support the raw water container 3; a raw water pumping pipe 5 which allows communication between the raw water container 3 and the cold water tank 2; a pump 6 provided at an intermediate portion of the raw water pumping pipe 5; a hot water tank 7 configured to store high temperature drinking water so that the high temperature drinking water can be discharged to the outside of the housing 1; a buffer tank 8 disposed above the hot water tank 7; and a hot water tank water supply pipe 9 which allows communication between the buffer tank 8 and the hot water tank 7.

The end portion of the raw water pumping pipe 5 on the up-stream side is provided with a joint potion 5a configured to be detachably connected to a water outlet port 11 of the raw water container 3. The end portion of the raw water pumping pipe 5 on the down-stream side is connected to the cold water tank 2. The raw water pumping pipe 5 extends downward from the joint portion 5a and is then redirected upward so that it passes through a position lower than the joint portion 5a. The pump 6 is provided in the raw water pumping pipe 5 at its portion lower than the joint portion 5a.

The pump 6 transfers the drinking water in the raw water pumping pipe 5 from the side of the raw water container 3 toward the cold water tank 2, and pumps out drinking water from the raw water container 3 through the raw water pumping pipe 5. A diaphragm pump can be used as the pump 6. While not shown, the diaphragm pump includes a diaphragm which reciprocates; a pump chamber whose volume is increased and decreased by the reciprocation of the diaphragm, the pump chamber including a suction port and a discharge port; a suction side check valve provided at the suction port and configured to allow only the flow of water into the pump chamber; and a discharge side check valve provided at the discharge port and configured to allow only the flow of water out of the pump chamber. The diaphragm pump sucks in drinking water from the suction port when the volume of the pump chamber is increasing due to the movement of the diaphragm in one direction, and discharges drinking water from the discharge port when the volume of the pump chamber is decreasing due to the movement of the diaphragm in the other direction.

Alternatively, a gear pump may be used as the pump 6. While not shown, the gear pump includes a casing; a pair of gears meshing with each other and housed inside the casing; and a suction chamber and a discharge chamber defined by the meshing portions of the pair of gears in the casing. The gear pump transfers drinking water trapped between the tooth spaces of the pair of gears and the inner surface of the casing of the gear pump from the side of the suction chamber toward the discharge chamber, by the rotation of the gears.

A flow rate sensor 12 is provided in the raw water pumping pipe 5 on the discharge side of the pump 6. When the flow rate sensor 12 detects that there is no drinking water flowing in the raw water pumping pipe 5 while the pump 6 is in operation, a container-replacement lamp placed on the front surface of the housing 1, which is not shown, is turned on to notify a user that the raw water container 3 needs to be replaced.

A first three-way valve 13 is provided in the raw water pumping pipe 5 at its portion between the pump 6 and the cold water tank 2 (preferably, at the end portion of the raw water pumping pipe 5 on the side of the cold water tank 2). Although the figures show an example in which the first three-way valve 13 is disposed at a position away from the cold water tank 2, the first three-way valve 13 may be directly connected to the cold water tank 2. A buffer tank water supply pipe 14 is connected to the first three-way valve 13 and allows communication between the first three-way valve 13 and the buffer tank 8. The end portion of the buffer tank water supply pipe 14 on the side of the buffer tank 8 is connected to an upper surface 8a of the buffer tank 8.

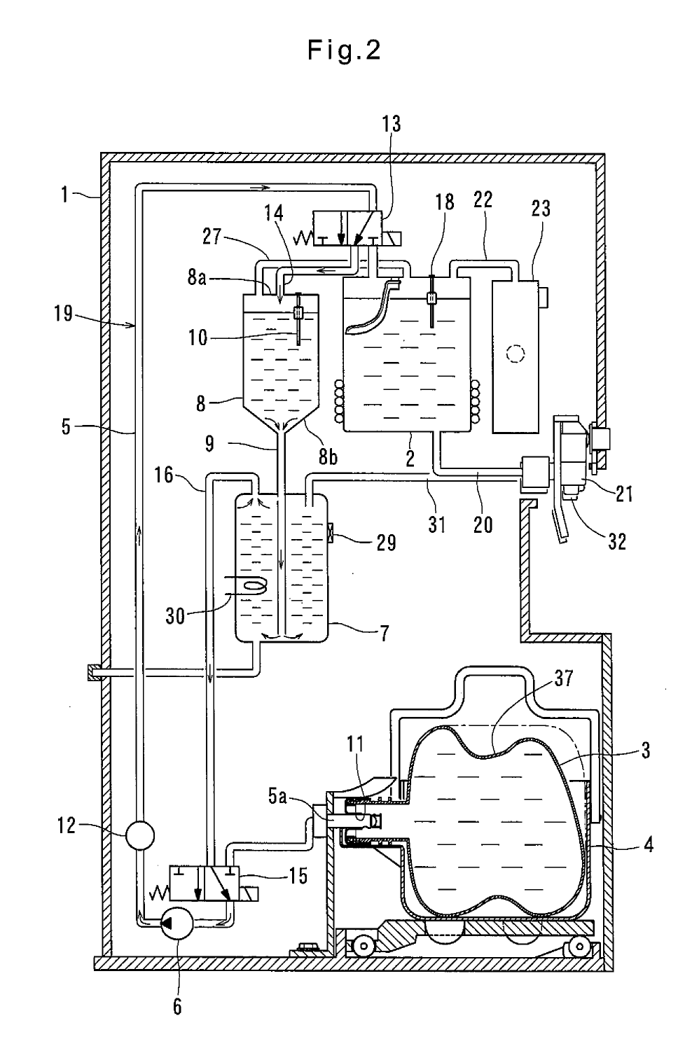

The first three-way valve 13 is configured to be capable of switching the flow of drinking water by being switched between a cold water tank-side connecting position (see FIG. 1) and a buffer tank-side connecting position (see FIG. 2). When switched to the cold water tank-side connecting position, the first three-way valve 13 allows communication between the pump 6 and the cold water tank 2 while blocking communication between the pump 6 and the buffer tank 8; and when switched to the buffer tank-side connecting position, the first three-way valve 1 blocks communication between the pump 6 and the cold water tank 2, and allows communication between the pump 6 and the buffer tank 8. In this embodiment, the first three-way valve 13 is a solenoid valve configured to be switched from the cold water tank-side connecting position to the buffer tank-side connecting position when energized, and from the buffer tank-side connecting position to the cold water tank-side connecting position when de-energized.

A second three-way valve 15 is provided in the portion of the raw water pumping pipe 5 between the pump 6 and the raw water container 3 (preferably, at the end portion of the raw water pumping pipe 5 on the side of the raw water container 3). Although the figures show an example in which the second three-way valve 15 is disposed at a position away from the joint portion 5a, the second three-way valve 15 may be directly connected to the joint portion 5a. A circulation pipe 16 is connected to the second three-way valve 15 and configured to allow communication between the second three-way valve 15 and the hot water tank 7. The end portion of the circulation pipe 16 on the side of the hot water tank 7 is connected to an upper surface 7a of the hot water tank 7.

The second three-way valve 15 is configured to be capable of switching the flow of drinking water by being switched between a raw water container-side connecting position (see FIG. 1) and a hot water tank-side connecting position (see FIG. 2). When switched to the raw water container-side connecting position, the second three-way valve 15 allows communication between the pump 6 and the raw water container 3, while blocking the communication between the pump 6 and the hot water tank 7; and when switched to the hot water tank-side connecting position (this position is hereinafter sometimes also referred to as a “circulation route-side connecting position”), the second three-way valve 15 blocks communication between the pump 6 and the raw water container 3, and allow communication between the pump 6 and the hot water tank 7. In this embodiment, the second three-way valve 15 is, as with the first three-way valve 13, a solenoid valve, and is configured to be switched from the raw water container-side connecting position to the hot water tank-side connecting position when energized, and from the hot water tank-side connecting position to the raw water container-side connecting position when de-energized.

As shown in FIG. 2, when the first three-way valve 13 is switched to the buffer tank-side connecting position and the second three-way valve 15 is switched to the circulation route-side connecting position, a circulation route 19 is formed through which drinking water can be circulated by way of the hot water tank 7. The circulation route 19 comprises the hot water tank 7, the circulation pipe 16, the second three-way valve 15, the portion of the raw water pumping pipe 5 between the second three-way valve 15 and the first three-way valve 13, the first three-way valve 13, the buffer tank water supply pipe 14, the buffer tank 8, and the hot water tank water supply pipe 9, which are arranged in the above-mentioned order. The pump 6 is provided at an intermediate portion of the circulation route 19.

As shown in FIG. 1, the cold water tank 2 contains air and drinking water in upper and lower layers. A cooling device 17 is attached to the cold water tank 2, and is configured to cool the drinking water contained in the cold water tank 2. The cooling device 17 is positioned at the lower outer periphery of the cold water tank 2, so that the drinking water inside the cold water tank 2 is maintained at a low temperature (about 5 degrees Celsius).

A water level sensor 18 is installed in the cold water tank 2 and configured to detect the water level of the drinking water accumulated in the cold water tank 2. When the water level detected by the water level sensor 18 falls to a predetermined level, the pump 6 is actuated with the first three-way valve 13 switched to the cold water tank-side connecting position, and pumps up drinking water from the raw water container 3 into the cold water tank 2.

A cold water discharging pipe 20 is connected to the bottom surface of the cold water tank 2 such that low temperature drinking water in the cold water tank 2 can be discharged to the outside of the housing 1 through the cold water discharging pipe 20. The cold water discharging pipe 20 is provided with a cold water cock 21 capable of being operated from outside the housing 1, and low temperature drinking water can be discharged from the cold water tank 2 into a cup or the like by opening the cold water cock 21. The capacity of the cold water tank 2 to hold drinking water is less than the capacity of the raw water container 3, and is about from 2 to 4 liters.

An air sterilization chamber 23 is connected to the cold water tank 2 through an air introduction passage 22. The air sterilization chamber 23 includes a hollow casing 25 provided with an air inlet port 24; and an ozone generator 26 provided within the casing 25. The ozone generator 26 may be, for example, a low-pressure mercury lamp which irradiates ultraviolet light to the oxygen in the air to convert oxygen to ozone, or a silent discharge apparatus in which an AC voltage is applied between an opposed pair of electrodes covered with insulators to convert oxygen between the electrodes to ozone. The air sterilization chamber 23 is maintained in a state in which the casing 25 thereof is filled with ozone at all times, by energizing the ozone generator 26 at regular intervals to generate ozone.

When the water level in the cold water tank 2 falls, air is introduced into the cold water tank 2 through the air introduction passage 22, such that the pressure in the cold water tank 2 is maintained at atmospheric pressure. Since air introduced into the cold water tank 2 is sterilized with ozone by passing through the air sterilization chamber 23, the air inside the cold water tank 2 is maintained clean.

The buffer tank 8 contains air and drinking water in upper and lower layers. An air pipe 27 is connected to the upper surface 8a of the buffer tank 8. The air layer in the buffer tank 8 and the air layer in the cold water tank 2 communicate with each other through the air pipe 27, so that the interior of the buffer tank 8 is maintained at atmospheric pressure.

A water level sensor 10 is installed in the buffer tank 8, and configured to detect the water level of the drinking water accumulated in the buffer tank 8. When the water level detected by the water level sensor 10 falls below a predetermined level, the pump 6 is actuated with the first three-way valve 13 switched to the buffer tank-side connecting position, and pumps up drinking water from the raw water container 3 into the buffer tank 8.

The capacity of the buffer tank 8 to hold drinking water is less than the capacity of the hot water tank 7, and is about from 0.2 to 0.5 liter. As described later, the drinking water in the buffer tank 8 plays a role to push drinking water in the hot water tank 7 to the outside, when high temperature drinking water in the hot water tank 7 is discharged to the outside. Therefore, the buffer tank 8 preferably has a vertically elongated shape (for example, the shape of a cylinder whose height is larger than its diameter). With this arrangement, even if the capacity of the buffer tank 8 to hold drinking water is small, a relatively high pressure is produced at the lower portion of the buffer tank 8, and a force to push out the drinking water in the hot water tank 7 can be effectively obtained. Although the figures show an example in which the buffer tank 8 is disposed such that the water level in the buffer tank 8 is the same as, or lower than the water level in the cold water tank 2, the buffer tank 8 may be disposed such that the water level in the buffer tank 8 is higher than the water level in the cold water tank 2. With the latter arrangement, the difference in elevation between the water levels in the buffer tank 8 and the hot water tank 7 is increased, and a force to push out the drinking water in the hot water tank 7 to the outside can be effectively obtained.

A bottom surface 8b of the buffer tank 8 is formed in the shape of a cone to slope downward toward its center, and the hot water tank water supply pipe 9 is connected to the center of the bottom surface 8b of the buffer tank 8. The hot water tank water supply pipe 9 is connected to the hot water tank 7 disposed below the buffer tank 8. The bottom surface 8b of the buffer tank 8 is formed in the shape of a cone so that, when the sterilization operation to be described later is performed, high temperature drinking water can reach the portion of the bottom surface 8b along the outer periphery of the buffer tank 8, leaving no portion unsterilized.

The hot water tank 7 is completely filled with drinking water. The hot water tank 7 is provided with a temperature sensor 29 configured to detect the temperature of the drinking water in the hot water tank 7, and a heater 30 configured to heat the drinking water in the hot water tank 7. As the temperature detected by the temperature sensor 29 decreases and increases, the heater 30 is turned on and off so that the temperature of the drinking water in the hot water tank 7 can be maintained high (about 90 degrees Celsius). While an example in which a sheathed heater is used as the heater 30 is shown in the figures, a band heater may be used instead. The sheathed heater is a heating device including a heating wire housed in a metal pipe and configured to generate heat when energized, and is installed to extend through the wall of the hot water tank 7, and into the interior of the hot water tank 7. A band heater is a cylindrical heat generator in which a heating wire which generates heat when energized is embedded, and would be attached around the outer periphery of the hot water tank 7 in close contact therewith.

A hot water discharging pipe 31 is connected to the upper surface 7a of the hot water tank 7 such that high temperature drinking water accumulated in the upper portion of the hot water tank 7 can be discharged to the outside of the housing 1 through the hot water discharging pipe 31. The hot water discharging pipe 31 is provided with a hot water cock 32 capable of being operated from outside the housing 1, and high temperature drinking water can be discharged from the hot water tank 7 into a cup or the like by opening the hot water cock 32. When drinking water is discharged from the hot water tank 7, drinking water in the buffer tank 8 is introduced into the hot water tank 7 through the hot water tank water supply pipe 9, due to its own weight. Accordingly, the hot water tank 7 is maintained fully filled at all times. The capacity of the hot water tank 7 to hold drinking water is about from 1 to 2 liters.

A drain pipe 35 is connected to the bottom surface of the hot water tank 7, and extends to the exterior of the housing 1. The outlet port of the drain pipe 35 is closed with a plug 36. However, an on-off valve may be provided instead of the plug 36.

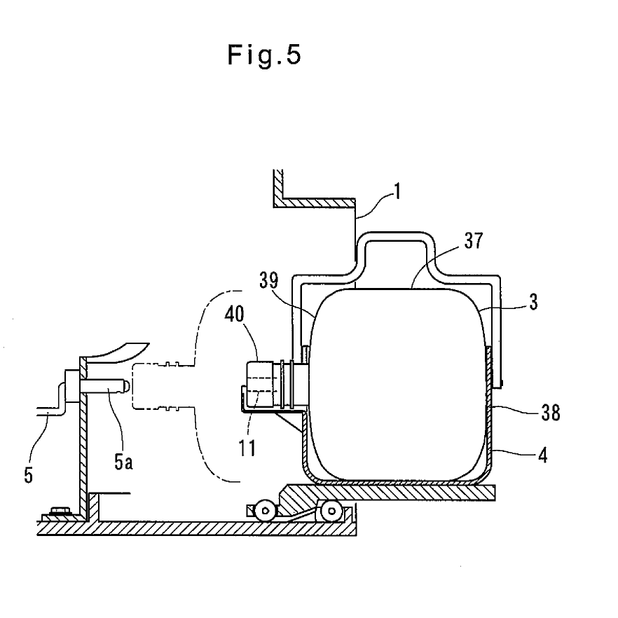

As shown in FIG. 5, the raw water container 3 includes a hollow cylindrical trunk portion 37; a bottom portion 38 provided at one end of the trunk portion 37; and a neck portion 40 provided on the other end of the trunk portion 37 through a shoulder portion 39, and including the water outlet port 11. The trunk portion 37 of the raw water container 3 is formed flexible so as to be collapsible as the amount of water remaining in the raw water container 3 decreases. The raw water container 3 is made by blow molding of polyethylene terephthalate (PET) resin. The capacity of the raw water container 3 is about from 10 to 20 liters when fully filled.

The raw water container 3 may be a bag made of a resin film, placed in a box such as a corrugated carton (so called “bag-in-box”), which bag is provided with a connecting member including a water outlet port 11, attached thereto by heat welding or the like.

The container holder 4 is supported movably in a horizontal direction between a stowed position (the position shown in FIG. 1) in which the raw water container 3 is stowed inside the housing 1, and a pulled out position (the position shown in FIG. 5) in which the raw water container 3 is moved out of the housing. The joint portion 5a is fixed in position inside the housing 1 such that the joint portion 5a is disconnected from the water outlet port 11 of the raw water container 3 when the container holder 4 is moved to the pulled out position, as shown in FIG. 5, and the joint portion 5a is connected to the water outlet port 11 of the raw water container 3 when the container holder 4 is moved to the stowed position, as shown in FIG. 1.

As the raw water pumping pipe 5 (excluding the joint portion 5a), a silicone tube can be used. However, since silicone has an oxygen permeability, proliferation of bacteria is more likely to occur in the raw water pumping pipe 5 due to the oxygen in the air that permeates through the silicone tube. Therefore, a metal pipe (such as a stainless steel pipe or a copper pipe) can be used as the raw water pumping pipe 5. With this arrangement, permeation of air through the wall of the raw water pumping pipe 5 can be prevented, thereby allowing for an effective prevention of the proliferation of bacteria in the raw water pumping pipe 5. In addition, heat resistance of the raw water pumping pipe 5 during the sterilization operation can also be secured. The use of a polyethylene tube or a heat-resistant, rigid polyvinyl chloride tube as the raw water pumping pipe 5 also allows for preventing the permeation of air through the pipe wall of the raw water pumping pipe 5, thereby preventing the proliferation of bacteria in the raw water pumping pipe 5.

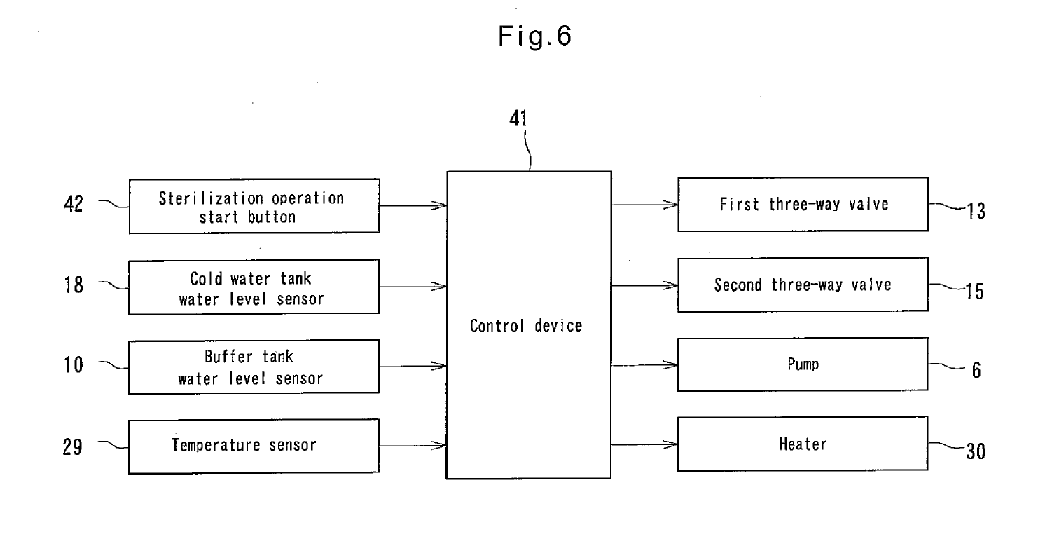

The heater 30, the pump 6, the first three-way valve 13, and the second three-way valve 15 are controlled by a control device 41 shown in FIG. 6. During the normal operation mode, the control device 41 controls the heater 30, the pump 6, the first three-way valve 13, and the second three-way valve 15 such that the water level in the cold water tank 2 and the water level in the buffer tank 8 are maintained within respective predetermined ranges, and the temperature in the hot water tank 7 is maintained within a predetermined range. On the other hand, during the sterilization operation mode, the control device 41 controls the heater 30, the pump 6, the first three-way valve 13, and the second three-way valve 15 such that the circulation route 19 (which comprises the hot water tank 7, the circulation pipe 16, the second three-way valve 15, the portion of the raw water pumping pipe 5 between the second three-way valve 15 and the first three-way valve 13, the first three-way valve 13, the buffer tank water supply pipe 14, the buffer tank 8, and the hot water tank water supply pipe 9) is sterilized at a high temperature with the high temperature drinking water in the hot water tank 7.

As shown in FIG. 6, the following signals are input to the control device 41: a signal sent from a sterilization operation start button 42, indicating whether or not a user has operated the button; a signal sent from the water level sensor 18, indicating the water level of the drinking water accumulated in the cold water tank 2; a signal sent from the water level sensor 10, indicating the water level of the drinking water accumulated in the buffer tank 8; and a signal sent from the temperature sensor 29, indicating the temperature of the drinking water in the hot water tank 7. Based on these signals, the following signals are output from the control device 41: a control signal to drive and stop the pump 6; a control signal to turn on and off the heater 30; a control signal to switch the position of the first three-way valve 13 so that the flow of water passing therethrough is switched; and a control signal to switch the position of the second three-way valve 15 so that the flow of water passing therethrough is switched.

When a user operates the sterilization operation start button 42; the initial sterilization operation starts. The control device 41 includes a built-in timer, and automatically carries out the second and following sterilization operations at the intervals of one day, based on the elapsed time since the initial sterilization operation, as measured by the timer. Further, it is also possible to configure the control device 41 such that, if the sterilization operation start button 42 is not operated, the control device 41 automatically carries out the sterilization operation at the intervals of one day, counting from immediately after the power of the water dispenser is turned on. The sterilization operation start button 42 is disposed on the front side of the housing 1.

It will now be described how the control device 41 works.

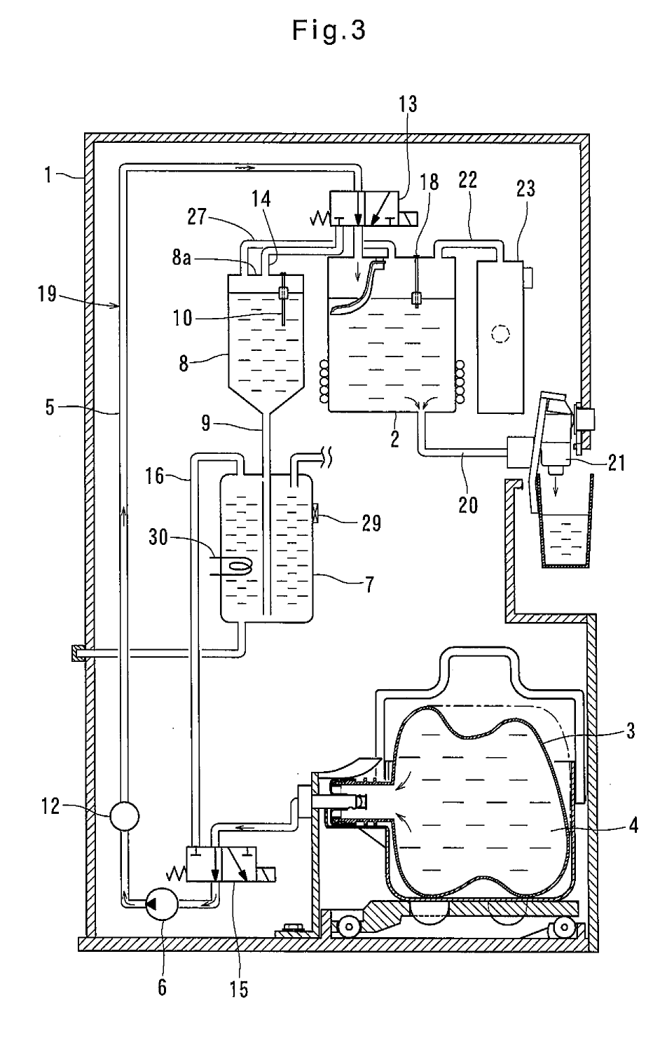

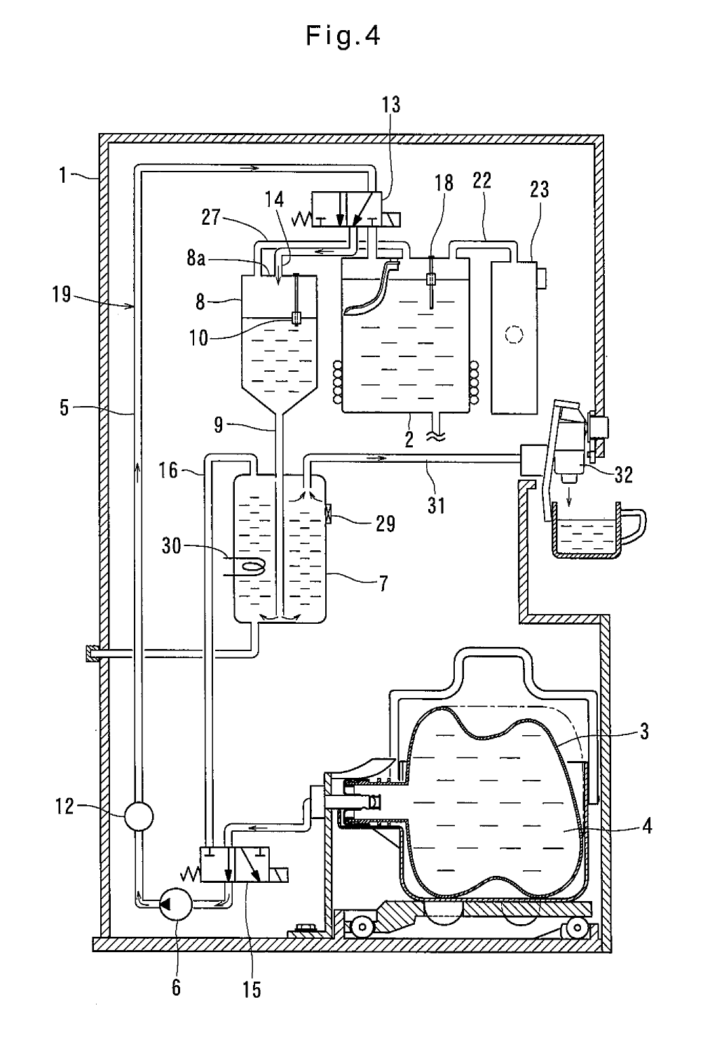

During the normal operation mode, the control device 41 carries out the water level control of the cold water tank 2 and the buffer tank 8. In particular, as shown in FIG. 3, when the water level in the cold water tank 2 falls below a predetermined lower limit water level, the control device 41 switches the first three-way valve 13 to the cold water tank-side connecting position, and drives the pump 6 in that state so that drinking water is pumped up from the raw water container 3 into the cold water tank 2; and when the water level in the cold water tank 2 is increased to reach a predetermined upper limit water level thereafter, the control device 41 deactivates the pump 6. As shown in FIG. 4, when the water level in the buffer tank 8 falls below a predetermined lower limit water level, the control device 41 switches the first three-way valve 13 to the buffer tank-side connecting position, and drives the pump 6 in that state so that drinking water is pumped up from the raw water container 3 into the buffer tank 8; and when the water level in the buffer tank 8 is increased to reach a predetermined upper limit water level thereafter, the control device 41 deactivates the pump 6.

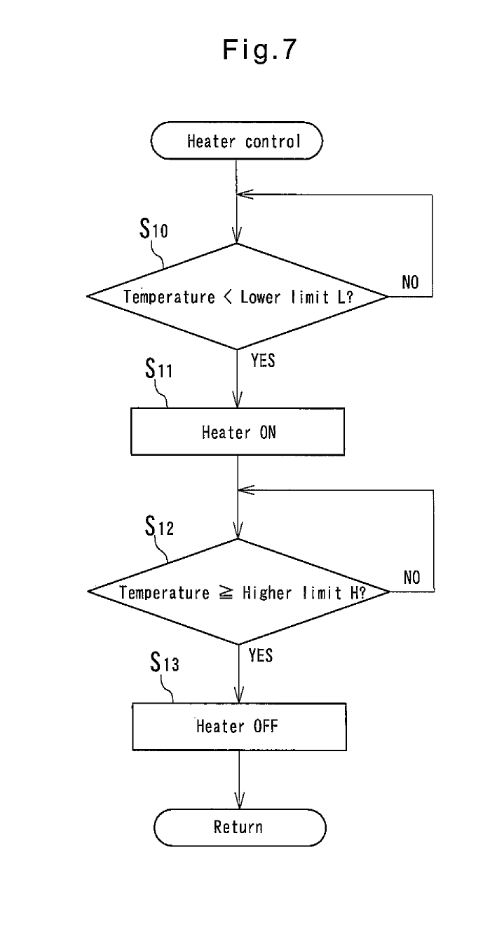

Further, during the normal operation mode, the control device 41 carries out the heater control of the hot water tank 7, concurrently with the above described water level control. The heater control is carried out, for example, according to the routine shown in FIG. 7. When the temperature in the hot water tank 7 falls below a predetermined lower limit temperature L (for example, 85 degrees Celsius), the control device 41 turns on the heater 30 to raise the temperature in the hot water tank 7 (steps S₁₀ and S₁₁). When the temperature in the hot water tank 7 is increased to reach an upper limit temperature 11 (for example, 90 degrees Celsius) thereafter, the control device 41 turns off the heater 30 (steps S₁₂ and S₁₃).

During the sterilization operation mode, as shown in FIG. 2, the first three-way valve 13 is switched to the buffer tank-side connecting position and the second three-way valve 15 is switched to the circulation route-side connecting position to form the circulation route 19, and in that state, the above described heater control of the hot water tank 7 is carried out concurrently with an intermittent pump drive control, in which the pump 6 is driven intermittently corresponding to the temperature change in the hot water tank 7.

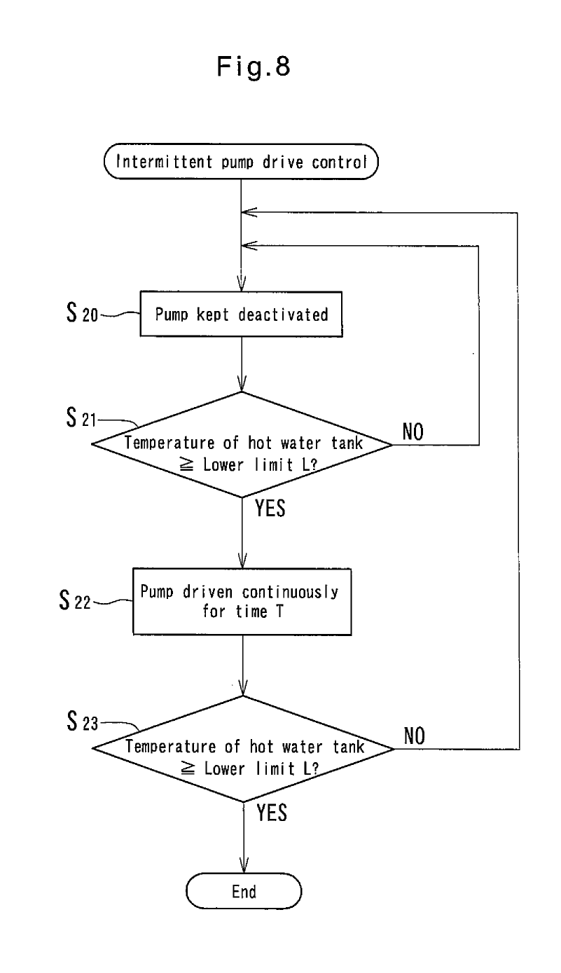

The intermittent pump drive control is carried out, for example, according to the routine shown in FIG. 8. First, when the temperature in the hot water tank 7 is below a predetermined high temperature (the lower limit temperature L set in the heater control in the figures), the control device 41 carries out a first operation (steps S₂₀ and S₂₁) in which the pump 6 is maintained in a deactivated state until the temperature in the hot water tank 7 is increased to reach the predetermined high temperature by the heater control. The predetermined high temperature is set to a temperature higher than at least the lowest temperature at which the sterilization can be achieved (65 degrees Celsius) (but not more than the upper limit temperature H set in the heater control). The predetermined high temperature as described above is preferably the same temperature as the lower limit temperature L set in the heater control (for example, 85 degrees Celsius). With this arrangement, when the above described heater control is carried out using a thermostat as the temperature sensor 29, it is possible to utilize the on/off function of the thermostat to carry out the first operation of the pump 6 (steps S₂₀ and S₂₁). Alternatively, however, the predetermined high temperature may be the same temperature as the upper limit temperature H set in the heater control (for example, 90 degrees Celsius).

When the temperature in the hot water tank 7 is increased to reach the above described predetermined high temperature (lower limit temperature L set in the heater control) by the heater control, the control device 41 carries out a second operation (step S₂₂), in which the pump 6 is continuously driven for a predetermined period of time T. During the second operation (step S₂₂), since drinking water in the circulation route 19 (particularly, drinking water in the buffer tank 8 in the embodiment) is introduced into the hot water tank 7, the temperature in the hot water tank 7 falls. When the temperature in the hot water tank 7 falls below the lower limit temperature L set in the heater control, the heater 30 is turned on.

In the embodiment, the predetermined period of time T is determined to be the same as, or shorter than, the period of time required for the pump 6 to pump out the amount of drinking water equivalent to the capacity of the hot water tank 7. For example, if the capacity of the hot water tank 7 to hold drinking water is 1.2 liters, and the amount of drinking water the pump 6 pumps out per minute is 1 liter, the predetermined period of time T, which is the length of time during which the pump 6 is continuously driven in the step S₂₂, is determined to be the same as the period of time required for the pump 6 to pump out 1.2 liters of drinking water (1 minute and 12 seconds), or a period of time shorter than that (for example, 1 minute).

Further, the predetermined period of time T is determined to be the same as, or longer than, the period of time required for the pump 6 to pump out the amount of drinking water equivalent to the capacity of the buffer tank 8. For example, if the capacity of the drinking water of the buffer tank 8 is 0.3 liter, and the amount of drinking water the pump 6 pumps out per minute is 1 liter, the predetermined period of time T, during which the pump 6 is continuously driven in the step S₂₂, is determined to be the same as the period of time required for the pump 6 to pump out 0.3 liter of drinking water (18 seconds), or a period of time longer than that (for example, 1 minute).

The control device 41 determines whether or not the temperature in the hot water tank 7 after carrying out the second operation (step S₂₂) is equal to or higher than the lower limit temperature L set in the heater control (step S₂₃), and if it is determined that the temperature in the hot water tank 7 is lower than the lower limit temperature L, the control device 41 returns to the first operation (steps S₂₀ and S₂₁). The first operation (steps S₂₀ and S₂₁) and the second operation (step S₂₂) are carried out alternately and repeatedly, thereafter.

When the control device 41 determines that the temperature in the hot water tank 7 after carrying out the second operation (step S₂₂) is equal to or higher than the sterilization temperature (the lower limit temperature L set in the heater control, in the figures) (step S₂₃), it is considered that the overall temperature of the drinking water in the circulation route 19 has been increased to reach the sterilization temperature, and thus, the repetitive alternate execution of the first and the second operations in the intermittent pump drive control is terminated. The sterilization temperature is set to a temperature higher than the lowest temperature at which the sterilization can be achieved (65 degrees Celsius), and lower than the upper limit temperature H set in the heater control. The sterilization temperature may be the same temperature as the lower limit temperature L set in the heater control (for example, 85 degrees Celsius).

When the intermittent pump drive control (FIG. 8) is completed, if the pump 6 is further driven while concurrently carrying out the heater control of the hot water tank 7, the circulation route 19 can be reliably sterilized by the high temperature drinking water which has been heated to the sterilization temperature. At this time, a third operation in which the pump 6 is continuously driven for a predetermined first period of time (for example, 2 minutes) may be repeatedly carried out, alternating with a fourth operation which is carried out after every third operation and in which the pump 6 is maintained in a deactivated state for a predetermined second period of time (for example, 2 minutes). This allows for reducing the total number of revolutions of the pump 6 required to circulate high temperature drinking water heated to the sterilization temperature through the circulation route 19.

In addition, the control device 41 drives the pump 6 such that the rotational speed of the pump 6 during the sterilization operation mode (in other words, in step S₂₂ in the intermittent pump drive control) is lower than the rotational speed of the pump 6 during the normal operation mode. With this arrangement, the driving sound of the pump 6 during the sterilization operation mode can be reduced, and it is possible to ensure quiet sterilization operation, which is expected to be carried out late at night.

The above described water dispenser is excellent in terms of sanitation, since the circulation route 19 including the raw water pumping pipe 5 and the buffer tank 8, which come into contact with near-normal temperature drinking water pumped out from the raw water container 3, can be sterilized by high temperature drinking water in the hot water tank 7.

Since this water dispenser is configured such that during the sterilization operation mode, the pump 6 is maintained in a deactivated state while the temperature in the hot water tank 7 has not yet been increased to the predetermined high temperature (lower limit temperature L in the embodiment), and the pump 6 is driven to pump out high temperature drinking water from the hot water tank 7 when the temperature in the hot water tank 7 is increased to the predetermined high temperature (lower limit temperature L), it is possible to minimize the total number of revolutions of the pump 6 required until the overall temperature of the drinking water circulating through the circulation route is increased to the sterilization temperature. Accordingly, the total number of revolutions of the pump 6 required per sterilization operation can be reduced, and it is possible to secure a long service life of the pump 6 even if the sterilization operation is carried out frequently (for example, about once a day). As a result, the sanitation of the water dispenser can be improved.

Further, in the present water dispenser, it is possible to efficiently prolong the service life of the pump 6, since the predetermined period of time T, which is the length of time during which the pump 6 is driven continuously in the second operation (step S₂₂) in the intermittent pump drive control, is determined to be the same as, or shorter than, the period of time required for the pump 6 to pump out the amount of drinking water equivalent to the capacity of the hot water tank 7. In other words, by the time the pump 6 has pumped out the amount of drinking water equivalent to the capacity of the hot water tank 7, it is considered that the high temperature drinking water in the hot water tank 7 has been substantially completely replaced, and further driving the pump 6 continuously will only shorten the life of the pump 6 unnecessarily. Therefore, as described above, if the predetermined period of time T during which the pump 6 is driven continuously in the second operation (step S₂₂) is determined to be the same as, or shorter than, the period of time required for the pump 6 to pump out the amount of drinking water equivalent to the capacity of the hot water tank 7, it is possible to efficiently prolong the service life of the pump 6 by not unnecessarily driving the pump 6.

Still further, in the present water dispenser, since the predetermined period of time T during which the pump 6 is driven continuously in the second operation (step S₂₂) in the intermittent pump drive control is determined to be the same as, or longer than, the period of time required for the pump 6 to pump out the amount of drinking water equivalent to the capacity of the buffer thank 8, the drinking water in the buffer tank 8 can be replaced with high temperature drinking water every time when the continuous drive of the pump 6 is carried out, and the buffer tank 8 can be efficiently sterilized.

In the above described embodiment, an example of the water dispenser is described in which the cold water tank 2 is not included in the circulation route 19, through which drinking water is circulated by way of the hot water tank 7 during the sterilization operation mode. However the present invention is also applicable to a water dispenser in which the cold water tank 2 is included in the circulation route (in other words, a type of water dispenser in which the cold water tank 2 is configured to be sterilized by the high temperature drinking water in the hot water tank 7).

### DESCRIPTION OF SYMBOLS

6 pump
7 hot water tank
19 circulation route
30 heater
41 control device

1. A water dispenser comprising:
a hot water tank configured to store high temperature drinking water to be discharged to outside of the water dispenser;
a heater configured to heat the drinking water in the hot water tank to high-temperature drinking water;
a circulation route configured such that drinking water can be circulated through the circulation route by way of the hot water tank;
a pump provided at an intermediate portion of the circulation route; and
a control device configured to control the heater and the pump such that the circulation route can be sterilized at a high temperature with the high temperature drinking water in the hot water tank;
wherein, during a sterilization operation of the circulation route, the control device is configured to perform:
a heater control in which the control device turns on the heater when a temperature in the hot water tank falls below a predetermined lower limit temperature, and turns off the heater when the temperature in the hot water tank is increased to reach a predetermined upper limit temperature, concurrently with
an intermittent pump drive control in which the control device performs a first operation in which the pump is maintained in a deactivated state while the temperature in the hot water tank is lower than a predetermined high temperature, alternately with a second operation in which the pump is driven continuously for a predetermined period of time when the temperature in the hot water tank is increased to reach the predetermined high temperature by the heater control.

2. The water dispenser according to claim 1, wherein the predetermined period of time, which is a length of time during which the pump is driven continuously in the second operation, is determined to be the same as, or shorter than, a period of time required for the pump to pump out an amount of drinking water equivalent to a capacity of the hot water tank.
